(19) United States
(12) Patent Application Publication
(10) Pub. No.: US 2009/0184858 A1
(43) Pub. Date: Jul. 23, 2009

(54) Status Indication for Building Automation Systems

(75) Inventors: Gary Kiwimagi, Greeley, CO (US); Craig Ogawa, Loveland, CO (US); Matt Staples, Fort Collins, CO (US); Scott Hesse, Longmont, CO (US); Kevin Gross, Boulder, CO (US); Dennis Clark, Fort Collins, CO (US)

Correspondence Address: BERENBAUM, WEINSHIENK & EASON, P.C, 370 17TH STREET, SUITE 4800, DENVER, CO, 80202, US

(73) Assignee: COLORADO VNET LLC, Loveland, CO (US)

(21) Appl. No.: 12/347,975

(22) Filed: Dec. 31, 2008

Related U.S. Application Data
(60) Provisional application No. 61/018,313, filed on Dec. 31, 2007.

(51) Int. Cl. G08C 19/12; G08B 21/00

(52) U.S. Cl. 341/176; 340/540

(57) ABSTRACT

Status indication of a device to be controlled in a building automation system; including functionalities and/or devices for recognizing a command signal that has been sent from a controlling device to a device to be controlled; and, interpreting the state of the device to be controlled from the command signal.

### CROSS-REFERENCE TO RELATED APPLICATIONS

The present application claims the benefit of and priority from the U.S. Provisional Application No. 61/018,313, filed 31 Dec. 2007, entitled “PASSIVE STATUS GENERATION FOR LIGHTING CONTROL SYSTEMS”; the subject matter of which hereby being specifically incorporated herein by reference for all that it discloses and teaches.

### BACKGROUND

Conventionally, advanced building automation systems allow lights, appliances or other building automation devices all over a building or other facility to be remotely controlled and monitored from one or more user interfaces or keypads. A typical user interface for these systems is a keypad with status indicators. Pressing a key on the keypad provides a command signal which energizes a light or invokes a lighting scene or other building automation scenario. An indicator associated with the key may also be made to light or otherwise provide indication in acknowledgement of completion of the desired action. Typically, pressing the key a second time extinguishes the lights or terminates the automation scenario, and also extinguishes the indicator as acknowledgement.

In early control systems, the indicator was managed locally. Pressing the key would merely toggle the state of the indicator. The indicator could easily get out of sync with the true state if the system was adjusted from a different keypad or if a communications error caused one of the commands to become lost in transit.

Other contemporary systems either use a separate status reporting or retrieval mechanism, do not report true status or maintain all status information in a central processor for selective retrieval by a system component.

### SUMMARY

The following implementations and aspects thereof are described and illustrated in conjunction with systems, tools and methods which are meant to be exemplary and illustrative, not limiting in scope. In various implementations, one or more of the above-described issues have been reduced or eliminated, while other implementations are directed to other improvements.

In view of the foregoing it is a general aspect of the presently described developments to provide for status indication of a device to be controlled in a building automation system; by including functionalities and/or devices for recognizing a command signal that has been sent from a controlling device to a device to be controlled; and, interpreting the state of the device to be controlled from the command signal.

The foregoing specific aspects and advantages of the present developments are illustrative of those which can be achieved by these developments and are not intended to be exhaustive or limiting of the possible advantages which can be realized. Thus, those and other aspects and advantages of these developments will be apparent from the description herein or can be learned from practicing the disclosure hereof, both as embodied herein or as modified in view of any variations which may be apparent to those skilled in the art. Thus, in addition to the exemplary aspects and embodiments described above, further aspects and embodiments will become apparent by reference to and by study of the following descriptions.

### BRIEF DESCRIPTION OF THE DRAWINGS

In the drawings:

FIG. 1 is a schematic representation of a network of building automation devices according to the developments hereof;

FIG. 2 is an alternative schematic representation of a network of building automation devices;

FIG. 3 is yet another alternative schematic representation of a network of building automation devices; and,

FIG. 4 is a flow chart of a methodology hereof.

### DETAILED DESCRIPTION

In the herein-described developments, building automation device status may be interpreted or inferred by receiving or listening in on the event messages used to control the system. Deriving status information from a control message removes the additional communications overhead of subsequently polling for status and thereby generating an additional status message communication. In a primary simple example, status can be inferred, passively or actively, in accordance herewith by listening in on the event messages sent out by other devices. For example, following transmission of an “On” command to a specific fixture or other device to be controlled, it can be assumed or interpreted that the fixture is in indeed in the “On” state; there being no further need to ask the fixture to confirm whether it is indeed “On”. An indication of this “On” state can then also be generated, a sort of passive status generation.

By contrast, other systems either use a separate status retrieval mechanism, do not report true status or maintain all status information in a central processor for universal retrieval by any system component. The current system, on the other hand, accomplishes status reporting via interpretation of the control communications. The herein described systems or means or mechanisms of obtaining and tracking system state minimize unnecessary communications. The same messages used to control the devices within the automation system can thus be used to update status indicators. This approach results in a simplified implementation and reduced communications overhead compared to a system utilizing separate messaging for state information. Often, the presently-disclosed systems may be involved in or use a communications scheme, e.g., wireless, where messaging bandwidth is at a premium. The developments hereof can thus minimize communication overhead or like burdens on a communications system whether in time or bandwidth.

The present systems are unique in that they offer rich feature sets but do not require a central processor to accomplish their functions. Implementations of similar distributed systems may involve communications via a relatively high-bandwidth CAN bus. For such, or wireless versions of the present technology developments to work reliably, optimization of communications protocols have been developed.

A system hereof can include a number of types of building automation devices from lighting to audio to video to temperature control, inter alia. In a first example, use of intelligent light switches herewith are described. Whether for lighting or otherwise, each of such switches may include a user interface, as for example, in the form of a touch sensitive panel, an associated set of indicators such as LED indicators, and in some instances, a transceiver, e.g., an IEEE 802.15.4 (ZigBee) transceiver, a microcontroller and one or more transconductive devices, e.g., a TRIAC. Such an embodiment may include the microcontroller and the transceiver and either the transconductive device(s) and/or the user interface. A system generally would include two or more of these devices. Other implementations can include different control/controllable devices and other communications hardware/software such as CAN (Controller Area Network).

End-user software may be employed to define desired operation of each of the user interface inputs, e.g., buttons, and their associated indicators. The result can be a set of scripts, one for each device in the system. The scripts can then be downloaded into the memories of the microcontrollers in the devices of the system. The scripts could then direct the devices as to appropriate responses to button presses and message receipts.

### Example 1

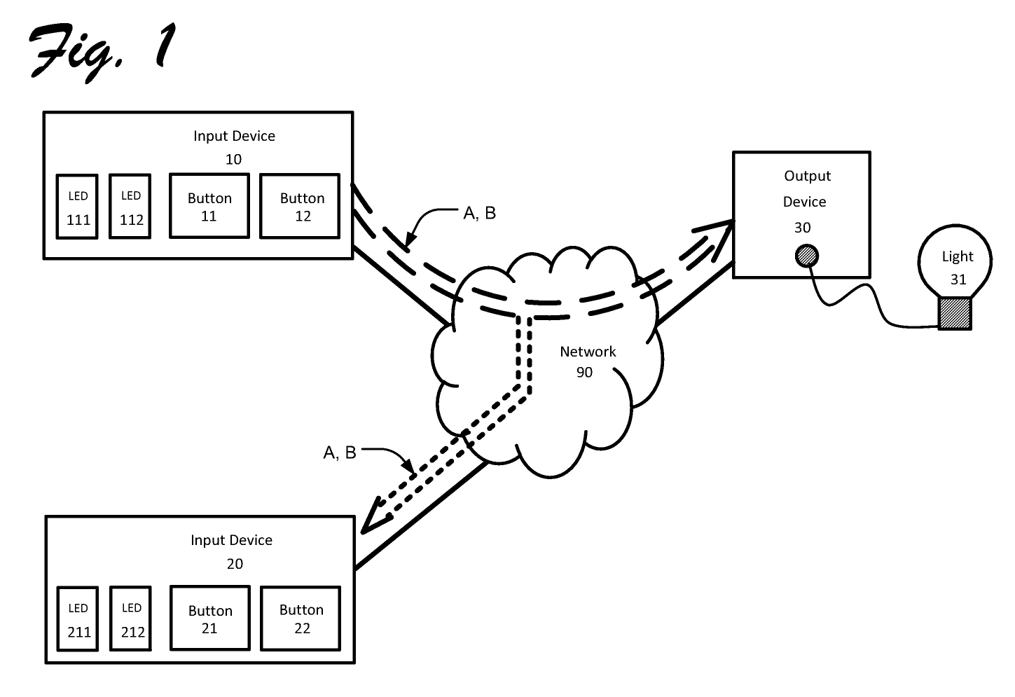

In a first, simple example, see e.g., FIG. 1, a user may define a respective first input mechanism, e.g., a button, here, particularly, e.g., buttons 11 and 21 respectively, on each of two input devices 10 and 20, as effective to turn on a device 31, e.g., light 31 connected to an output device 30. A second input mechanism, or button 12 and 22 on each of respective devices 10 and 20 may be configured to turn off the same light 31. Note, the device-to-be-controlled 31 may be a light or other building automation device such as audio, video, climate control, time, alarm, or otherwise. The input device or devices may also be referred to as control or command devices, and may have indication of state functionalities as well.

For this scenario, the scripts on devices 10 and 20 would direct each such device 10, 20 to transmit, through a network 90, a command message A when either of buttons 11 or 21 is touched and a message B when either of respective buttons 12 or 22 is depressed. In this example, scripts on device 30 could direct the device 30 to energize the attached light 31 on receipt of message A and to de-energize on receipt of message B.

Devices 10 and 20 may also be responsible for managing state as displayed, for example, on LED or other indicators associated with each of their two buttons (note, the indicators may be within and/or otherwise form a part of the buttons themselves, or may be separate or discrete geographically/locationally as shown in FIG. 1). In this simple example, scripts inform the devices 10, 20 that on communication or transmission/receipt of message A from either device 10, 20, the respective indicators 111, 211 for each of the first buttons 11, 21 are to be lit and the indicators 112, 212 for each of the second buttons 12, 22 are to be extinguished. When message B is communicated/received, indicators 111, 211 are extinguished and indicators 112, 212 are lit. Note, the message A or B is transmitted in the FIG. 1 exemplar view from device 10 to device 30, but, simultaneously read by or otherwise communicated to device 20 to effectuate this state interpretation and consequent indication. Thus, the second device 20 interprets the state of the device 31 via recognition of the command signal from the first input device 10 and not from the device 31 or otherwise.

### Example 2

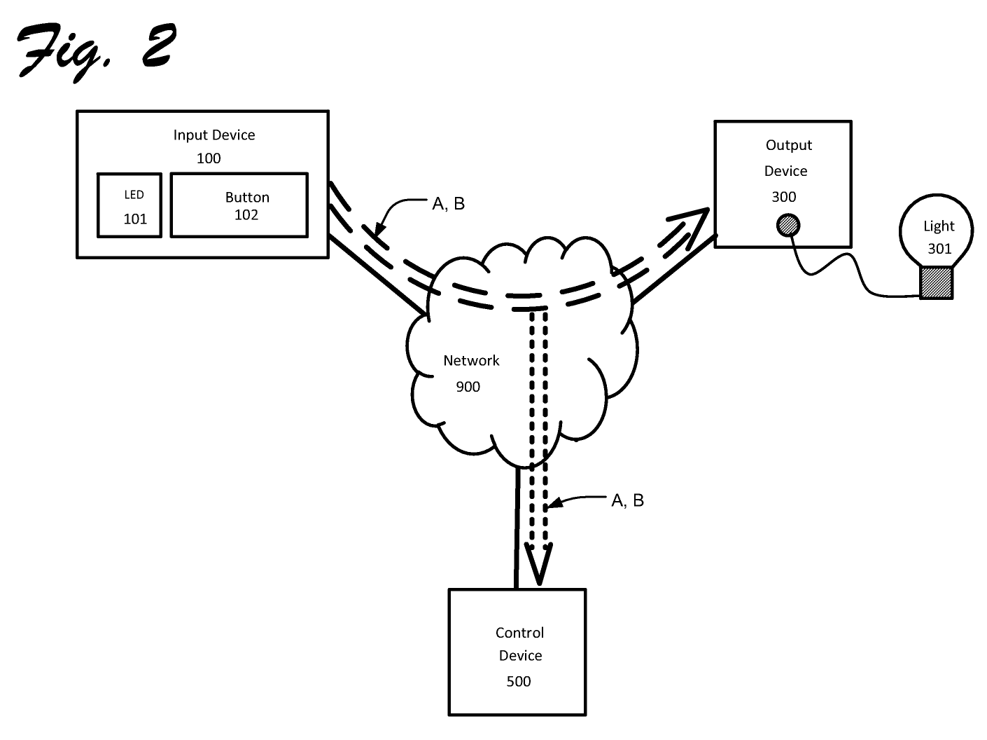

In a slight variation of this first example, in Example 2, see also FIG. 2, the communications A or B from an input device 100 through a network 900 to an output device 300 (with, e.g., a light 301 connected thereto), can be picked up or otherwise read or communicated to a control device 500 which could be a central system controller which could then interpret the state of the output devices 300, 301 via those commands A, B and not by other communication to or from devices 300, 301. The central control device 500 might also issue commands (not shown), or otherwise communicate state to other devices or otherwise (not shown, either). Note also that in this example only a single button 102 and a single LED indicator 101 are shown, these being representative, in some examples, of toggle types of command structures such that a first touch of the button could indicate the A command (e.g., light “On”), with a consequent lighting of the indicator 101, and then a second touch could be indicative of the alternative B command (e.g., light “Off”), with a consequent extinguishing of the indicator 101.

### Example 3

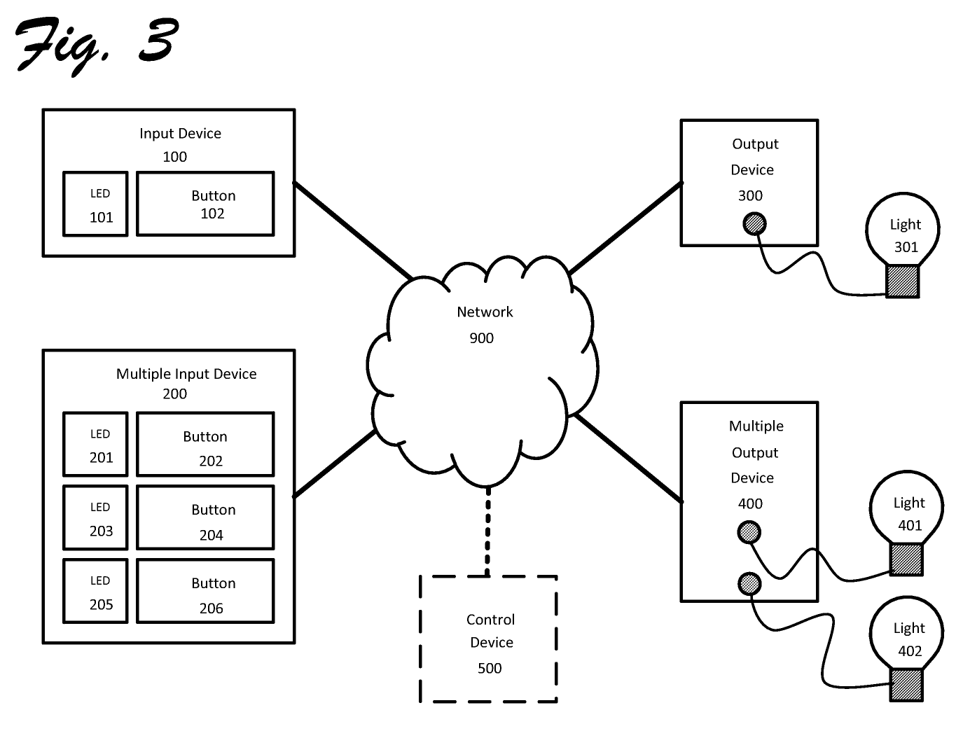

A more specific example, Example 3, below, see also FIG. 3, is given below to demonstrate the capabilities of this approach and some of the considerations in play deriving state information from command messages.

In this example, there are two input devices 100 and 200 shown (though of course others could be used as well, and see the optional central controller 500 set forth in dashed lines). On/in these input devices 100 and 200 are number of buttons and indicators, here LEDs, noting that device 200 is a multiple input device. Of these, LED (101) is associated with the “on/off state” of the corresponding “scene” controlled by Button (102); LED (201) is associated with the “on/off state” of the corresponding “scene” controlled by Button (202); LED (203) is associated with the “on/off state” of the corresponding “scene” controlled by Button (204), and, LED (205) is associated with the “on/off state” of the corresponding “scene” controlled by Button (206). In this example, the intended destination state of a scene is the state that is set when the scene is being turned on. Scenes are turned on when their buttons are pushed with their LEDs off, i.e., moving to the on state from the off state, the off state having been indicated by the off LED. Pushing the button when its LED is on turns off the scene, i.e., moving to the off state from the on state, the on state having been indicated by the on LED.

In this example, button (102) can be established to set the following “scene” when it is pushed with its corresponding LED (101) off; namely, to turn on all three of lights 301, 401 and 402 (i.e., to set light (301) to 100%, set light (401) to 100%, and set light (402) to 100%). In this case, button (102) can alternatively turn “off” the same “scene” when it is pushed with its corresponding LED (101) on; namely, to turn off all the lights (301), (401), (402).

Correspondingly, the respective buttons 202, 204 and 206 could be more specifically programmed to control only respective ones of the lights 301, 401 and 402. For example, button (202) could be set to set the following “scene” when it is pushed with its corresponding LED (201) off—Set Light (301) to 100%. Button (202) may then alternatively set the following “scene” when it is pushed with its corresponding LED (201) on—Turn off Light (301). Similarly, Button (204) could be used to set the following “scene” when it is pushed with its corresponding LED (203) off—Set Light (401) to 100%; and, alternatively, Button (204) sets the following “scene” when it is pushed with its corresponding LED (203) on—Turn off Light (401). And, Button (206) sets the following “scene” when it is pushed with its corresponding LED (205) off—Set Light (402) to 100%; and, Button (206) sets the following “scene” when it is pushed with its corresponding LED (205) on—Turn off Light (402).

In such an example, it can be set that when an LED is associated with the “on/off state” of the “scene” controlled by its corresponding button, the LED will be on (i.e., lit up) when the scene is “on” and it will be off when its scene is “off”. Defining what it means for a scene to be “on” and “off” can be interesting for determining when the appropriate LED should be on (i.e. lit up) or off. Note, in this example, lights are shown in the FIG.; however, it may be that a variety of alternative automation devices might be the “controlled” devices operating at the receipt of a command signal.

From this, there may be one or more of several useful definitions for what it means for a scene to be “on” or “off”. For example; 1) A scene is on when all of its controllable devices (e.g., lights) are on to the exact values set by the scene (ALL EXACT). 2) A scene is on when all of its controllable devices (e.g., lights) are on at any value (ALL ON). 3) A scene is on when at least one of its controllable devices (e.g., lights) is on (ANY ON). Further examples can be derived herefrom. For the purpose of this example, EXAMPLE 3, option 1 (ALL EXACT) will be the working definition of what it means for a scene to be on. “A scene is on when all of its controllable devices (e.g., lights) are on to the exact values set by the scene.” Further we say that LED 101, 201, 203, and 205 are all using the same (ALL EXACT) definition. Table 1 provides an illustration.

TABLE 1

| | | LED | LED | LED | LED | Light | Light | Light |
|---|---|---|---|---|---|---|---|---|
| Line | Action | (101) | (201) | (203) | (205) | (301) | (401) | (402) |
| 1 | Initial | Off | Off | Off | Off | off | off | off |
| | State | | | | | | | |
| 2 | Button | On | On | On | On | 100% | 100% | 100% |
| | (102) | | | | | | | |
| | pressed | | | | | | | |
| 3 | Button | Off | Off | Off | Off | Off | Off | Off |
| | (102) | | | | | | | |
| | pressed | | | | | | | |
| 4 | Button | Off | On | Off | Off | 100% | Off | Off |
| | (202) | | | | | | | |
| | pressed | | | | | | | |
| 5 | Button | Off | On | On | Off | 100% | 100% | Off |
| | (204) | | | | | | | |
| | pressed | | | | | | | |
| 6 | Button | On | On | On | On | 100% | 100% | 100% |
| | (206) | | | | | | | |
| | pressed | | | | | | | |
| 7 | Button | Off | Off | On | On | Off | 100% | 100% |
| | (202) | | | | | | | |
| | pressed | | | | | | | |
| 8 | Button | Off | Off | Off | On | Off | Off | 100% |
| | (204) | | | | | | | |
| | pressed | | | | | | | |
| 9 | Button | Off | Off | Off | Off | Off | Off | Off |
| | (206) | | | | | | | |
| | pressed | | | | | | | |

In stepping through Table 1; starting with Line 1: an “Initial State” of the system is presented where everything is off. Then, in Line 2: Button 102 is pressed. As described above, Button 102 sets the following “scene” when it is pushed with its corresponding LED 101 off—{Set Light (301) to 100%; Set Light (401) to 100%; Set Light (402) to 100%}. It may then be observed that all lights 301, 402, and 402 have been set to 100%. Now to apply the rules hereof (ALL EXACT) to determine whether a “scene” is “on” or “off” and therefore whether its corresponding LED should be on (i.e. Lit up) or off; it is known from the above description relative to FIG. 3 that the “intended destination state” of lights 301, 401, and 402 is 100%. Since that EXACTLY matches the state that the lights are now in, the scene is determined to be “on” and the corresponding LED 101 is on. Moreover, by looking at the intended destination state for each scene it may be determined that all the LEDs are on. Thus, the status indicators on input device 200 are updated to on even though the command was generated and communicated from the input device 100.

Moving next to a new command/action, as shown in Line 3: Button 102 is pressed, and as described above for “Example 3” and FIG. 3, Button 102 turns “off” the “scene” when it is pushed with its corresponding LED (101) on—{Turn off Light (301), (401), (402)}. It may be observed that lights 301, 402, and 402 have been set to 0%. Now the rules may be applied, the (ALL EXACT) rules, to determine whether a “scene” is “on” or “off” and therefore whether its corresponding LED should be on (i.e. Lit up) or off. As described, the “intended destination state” of lights 301, 401, and 402 is 100%. Since that does NOT EXACTLY match the state that the lights are now in, the scene is determined to be “off” and the corresponding LED (101) is off. Moreover, by looking at the intended destination state for each scene it may be determined that all the LEDs are off. Thus, the status indicators on input device 200 are updated to off even though the command was generated and communicated from the input device 100.

Continuing in Table 1, in line 4, button 202 is pressed, this, as described above for EXAMPLE 3, corresponds to controlling, on/off, device 301, which is thus turned on in line 4. Similarly in lines 5 and 6 of Table 1, corresponding buttons 204 and 206 are consecutively pressed to achieve the change of status of the corresponding devices 401 and 402 to the on state. Line 6 provides the cumulative states. Then, if button 202 is pressed a second time, as indicated in line 7 of the Table, then, the device 301 would go to the off state. Similarly, in the next successive lines 8 and 9, pressings of buttons 204 and 206 lead to the off states for devices 401 and 402.

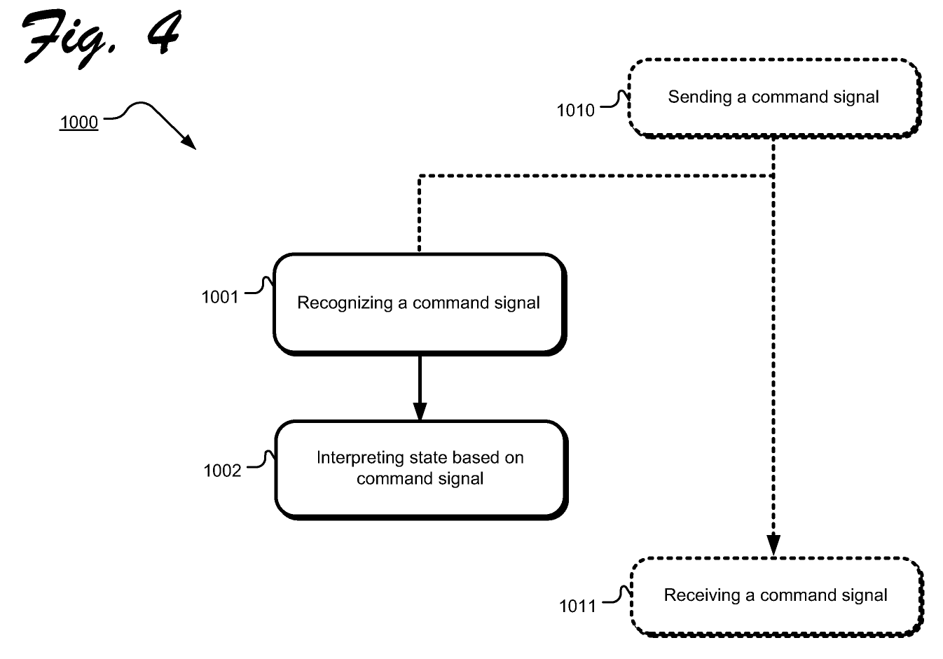

An exemplary implementation of the method for intended destination state management of state indicators is here described, see particularly FIG. 4. In a broad sense, a method 1000 hereof involves merely the recognizing 1001 of a command signal, and interpreting 1002 of that command signal as an indication of state. In the “recognizing,” there may be included the act of communication reception or other receipt of the message; noting that receipt and/or recognition may either include the mere passive hearing of or listening for appropriate command messages, or may include the more active seeking of the already existent command messages (though in this latter case, this is the seeking of messages, and not active polling of devices for state, which would thus require the more burdensome generation of a status response message). The “interpreting” may also include the indication, as by LED or other indicator, representing the state in a display or other communicative sense. In many instances the recognition of the signal and the interpretation are the self-same single step. The difference may only be in that the first involves the reception in one form or another of the input data representing the issuance of the command signal, the other in that it involves appropriately communicating the resultant awareness of state. Each of these operations 1001, 1002 may be performed substantially by the non-initiating, non-instantly-controlling device, as for example the device 20 in FIG. 1, the device 500 in FIG. 2, and the device 200 (and/or 500; and/or 100 when the input is from 200) in FIG. 3. However, the initiating device (e.g., devices 10 and 100 in the primary examples) might also perform these same functions even though they themselves providing the control/command signal.

In further sense, the method of recognition and interpretation may be part of further overall operations which may also include the herein, FIG. 4, indicated dashed line operations 1010 and 1011 of actually sending and receiving, respectively, the command signal. This latter sense involves the operations of the discrete devices 10, 100 for sending and devices 30, 300 and 400 for receiving of FIGS. 1-3. Note, the command signal is sent, operation 1010, and received, operation 1011, rather independently of and substantially without interference by the principles hereof. The present systems and methods make use of that command signal, whether passively receiving it, due to being connected on or to the same communications system, wire, cable, or wireless or the like, or whether by more active seeking of the command signal, again, otherwise being sent regardless the operations hereof. As introduced herein, the command signal could merely be intercepted, generally without diversion or alteration (though it is possible that in the interception, the command message could have been intercepted and transformed or relayed, translated, or amplified or otherwise, generally so long as the end product command provided the same instruction to the device to be controlled), or could be replicated or duplicatively sent at or from its initiation at the controlling input device.

A further set of more detailed methodologies will now be described. In a first sense, a first step may include the creation of Scenes and association thereof with actions (e.g. sensor inputs, keypad buttons, timers, anything that can generate an input message) on input devices. A second step may include the creation of variables to represent the “on/off” state of each controllable device in a scene. Then, as part of this second step, for each input device that has state indicators: further establishing for each state indicator on the input device that represents the “on/off” state of a scene and for each controllable device in the scene, creating a variable to represent the “on/off” state of the controllable device.

A third step may include configuring/programming each device to respond to input messages that affect its status indicators. This may include for each status indicator on this device, and/or for each controllable device that affects this status indicator, and/or for each scene that has the potential to change the state of this controllable device, and/or for each Input Device/Button that sets this scene that changes the state of this controllable device, then, creating configuration/programming information that will cause this device to set the “on/off” state variable for this controllable device in response to the input message generated by the Input Device/Button that invoked the scene that changes the state of this controllable device. Then, a fourth step may include configuring/programming each device to update its status indicators each time it receives an input message. This may include for each input message received taking any prescribed action associated with the message (i.e. turn on a light); and/or setting state variables (from step 2) using configuration/programming information (from step 3), and/or depending upon what rules are being used to determine the “on/off” state of the scene that each status indicator represents, evaluating all state variables to determine if all controllable devices are headed for their intended destination state; and, if the scene is determined to be “on”, turn on its status indicator, else turn it off.

In a further methodological example; a method for determining the intended destination state management of state indicator of and during the controlling of a single light and representing its state with an LED will now be described. As from the description of FIG. 3, but, only taking into account input device 100 and output device 300 with associated controlled device 301. Taken as givens: Button 102 on Input Device 100 will have been configured to turn on Light 301; LED 101 on Input Device 100 will have been configured to represent the “on/off” state of the scene controlled by Button 102 (specifically, if the light 301 is on the LED should be on); and, light 301 is not controlled by anything else in this example. Then, an operation of triggering Button 102 on Input Device 100 (e.g. someone pushes a button on a keypad) causes an input notification message to be delivered to Output Device 300, and to Input Device 100. Output Device 300 turns the connected light 301 on to 100%. Input Device 100 recognizes the communication of the command signal, and interprets this as an on state and sets a variable that represents Light 301 and then based on the rules chosen to determine the “on/off” state of a scene it checks all the controllable device variables (i.e. the variable for Light 301, etc. . . . ) to determine if the scene is “on” or “off”. If the scene is determined to be “on”, it turns on LED 101, if not, it turns off LED 101.

In a further variation of this method, e.g., this time taking into account multiple controlled devices and multiple indicators (FIG. 3 with devices 200 and 400 included). This method for intended destination state management of state indicators further includes at the triggering operation, the triggering by a Button on an Input Device (e.g. someone pushes a button on a keypad) which causes an input notification message to be delivered to all potentially affected Input and Output Devices. The Output Devices respond by adjusting their outputs (e.g. Lights) to the specified levels for the scene controlled by this input notification. The Input Devices respond by setting state variables that represent the outputs (e.g. Lights) and then checking all the variables for each LED on the Input Device to determine which scenes are “on” and “off” and then adjusting its LEDs to match.

As introduced above, the methodology may optionally include a central control device or multiple system devices which could also participate in providing either direct indicator (status) control messages, e.g., messages A or B; or, may provide status indication by interpretation of the command signals sent by other devices.

A number of alternatives may be involved. For a first such example, to ensure that the indicators match the true status of the lighting system in the presence of communications errors, the status sensing mechanism may be augmented by a communications acknowledgement system. Communications acknowledgement may provide the system feedback as to whether a message has been successfully received. Delivery failure can be compensated for by resending the original command or holding indicator and state where it was prior to the failed delivery.

Some communications channels prefer or only support directed messaging. Messages on these systems are directed to specific destinations and are not readily available to other devices listening in on the communications channel. On systems such as this, events that result in message transmissions (e.g. button touches), can be encoded with a list of devices which need to receive the message so that the command signal is directly sent to the output device enacting the command, as well as to any one or more input/status devices which would have status indications updated due to the change of information. The list of devices would include not only the devices controlling the lights which need to be adjusted in response to the message but any keypad devices which may need to update their state indicators in response to the system state change that these messages invoke. The lists of recipients for each message could be generated a priori as part of the same system configuration that generates the scripts for the devices, or could be updated at later times depending upon which devices are desired to provide the status indications.

Some further alternatives for implementation of the current system may include keypads which could frequently poll the system; the system could then be adapted to respond with status information which the keypads could use to adjust their indicators to match the reported state of the lighting system. Optionally a central device or multiple system devices could provide direct indicator (status) control messages.

Note, in the primary examples hereof; either on/off states were generally described; however, stepwise increases and/or decreases may also be used herewith as well as for example in turning up or down the volume of an audio or video player. In such examples, the basic principle of having a command signal (stepwise movement, e.g., up volume or down volume; or, up temperature, or down temperature; or, step-wise forwarding or rewinding of video or audio playback, inter alia) both recognized by a state device (either the self-same device as either commanding device or output device, or a third party device (e.g., devices 20, 200, 500 in the primary examples) not involved directly in the command initiation or reception) and interpreted for status indication.

In contrast to conventional systems, the presently described approach is unique in the building automation industry. Contemporary systems have either used a separate status reporting and/or retrieval mechanism, or they do not report true status or they maintain all status information in a central processor for universal retrieval by any system component. In either the former or the latter, a specific status message is additionally generated and sent, whether automatically, or upon specific request. In either of these cases, these status messages are additional burden on the communications system reducing effective bandwidth. Moreover, these conventional status reporting mechanisms are either unreliable, of limited functionality, rely upon a central server or consume excessive communications bandwidth which can limit the practical system size.

By contrast, the present developments perform differently from conventional systems in that status may generally be considered to be inferred from command messages. The present systems are typically involved in updating indicator state when commands are issued, but, at least updates when a new command is issued and recognized.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

What is claimed is:

1. A system for building automation including status indication of a device to be controlled within the building automation system; the system including:
a device-to-be-controlled;
at least one input device for controlling the device-to-be-controlled, the at least one input device being connected via a network to the device-to-be-controlled, the at least one input device also including a status indication for the device-to-be-controlled, and having a mechanism for issuing a command signal to the device-to-be-controlled;
wherein the at least one input device issues a command signal to the device-to-be-controlled, and the command signal is recognized and interpreted as indicative of the state of the device-to-be-controlled.

2. A system according to claim 1 further including a second input device, the second input device having at least a status indication for the device-to-be-controlled.

3. A system according to claim 1 further including a second input device, the second input device having at least a status indication for the device-to-be-controlled; the status indication being adapted to provide a status indication as a result of the recognition and interpretation of the command signal as indicative of the state of the device-to-be-controlled.

4. A system according to claim 1 further including a second input device, the second input device having at least a status indication for the device-to-be-controlled, and having a mechanism for issuing a command signal to the device-to-be-controlled.

5. A system according to claim 1 further including a second input device, the second input device having at least a status indication for the device-to-be-controlled, and having a mechanism for issuing a command signal to the device-to-be-controlled; the status indication being adapted to provide a status indication as a result of the recognition and interpretation of the command signal as indicative of the state of the device-to-be-controlled.

6. A system according to claim 1 wherein the device-to-be-controlled is a first device-to-be-controlled, the system also including a second device-to-be-controlled.

7. A system according to claim 1 wherein the device-to-be-controlled is a first device-to-be-controlled, the system also including a second device-to-be-controlled, and the system further including a second input device, the second input device having at least a status indication for each of the first and second devices-to-be-controlled, and having a mechanism for issuing a command signal to either or both the first and second devices-to-be-controlled; the status indication being adapted to provide a status indication as a result of the recognition and interpretation of the command signal as indicative of the state of either or both the first and second devices-to-be-controlled.

8. A system according to claim 1 wherein the input device is a multiple input device.

9. A system according to claim 1 further including a discrete control device, the discrete control device having at least a status indication for the device-to-be-controlled; the status indication being adapted to provide a status indication as a result of the recognition and interpretation of the command signal as indicative of the state of the device-to-be-controlled.

10. A system according to claim 1 wherein the network is one or more of wire-connected, cable, CAN, LAN, WAN or wireless.

11. A method for status indication of a device to be controlled in a building automation system; the method including:
recognizing a command signal that has been sent from a controlling device to a device to be controlled; and,
interpreting the state of the device to be controlled from the command signal.

12. A method according to claim 11 wherein the operation of recognizing occurs at one or more of the controlling device, the device to be controlled, a discrete input device and a discrete control device.

13. A method according to claim 11 wherein the operation of interpreting occurs at one or more of the controlling device, the device to be controlled, a discrete input device and a discrete control device.

14. A method according to claim 11 wherein the operation of recognizing includes at least one of passively receiving the command signal, and, actively seeking the command signal.

15. A method according to claim 11 wherein the operation of recognizing includes at least one of intercepting, with or without diversion, transformation or alteration, relaying, translating, amplifying, replication or duplication of the command signal.

16. A method according to claim 11 wherein the operation of interpreting includes at least one indicating or displaying or communicating the state of the device to be controlled.

17. A method according to claim 11 further including the sending of the command signal.

18. A method according to claim 11 further including the sending of the command signal, wherein one or both of the recognizing and interpreting occurs at a device discrete from the device performing the sending operation.

19. A method according to claim 11 further including the receiving of the command signal.

20. A method according to claim 11 further including the receiving of the command signal, wherein one or both of the recognizing and interpreting occurs at a device discrete from the device performing the receiving operation.
